(19) United States
(12) Patent Application Publication
(10) Pub. No.: US 2005/0282067 A1
(43) Pub. Date: Dec. 22, 2005

(54) Electrical battery

(76) Inventor: Timofei Gutkin, Hamburg, NJ (US)

Correspondence Address: ELY ZBOROVSKY PATENT BUREAU, 6 Schoolhouse Way, Dix Hills, NY, 11746, US

(21) Appl. No.: 11/135,151

(22) Filed: May 21, 2005

Related U.S. Application Data
(63) Continuation-in-part of application No. 11/082,061, filed on Mar. 17, 2005.
Application No. 11/082,061 is a continuation-in-part of application No. 10/787,960, filed on Mar. 1, 2004.
Application No. 10/787,960 is a continuation-in-part of application No. 09/883,154, filed on Jun. 18, 2001, now Pat. No. 6,699,615.

(51) Int. Cl. H01M 6/00

(52) U.S. Cl. 429/122; 429/163

(57) ABSTRACT

An electrical battery has a housing, two electrodes chargeable with electrical charges of different signs in a polarizable medium provided between the electrodes, the polarizable medium being formed as an electrolyte which does not electrochemically interact with the electrodes but provides electrical charges which are attracted to electrical charges of the electrodes and vice versa.

### CROSS-REFERENCE TO A RELATED APPLICATIONS

This application is a continuation-in-part of a patent application Ser. No. 11/082,061 filed on Mar. 17, 2005 which is a continuation-in-part of a patent application Ser. No. ______ filed on Mar. 1, 2004, which in turn is a continuation-in-part of patent application Ser. No. 09/883,154 filed on Jun. 18, 2001.

### BACKGROUND OF THE INVENTION

The present invention relates to electrical batteries.

It is well known that numerous attempts have been made to create electrical battery which can accumulate a great quantity of electrical energy and charge it as required to a consumer for a long period of time, for example to an electrical motor of a vehicle, so that the vehicle can drive over a significant mileage without recharging the battery. The existing electrical batteries are however still inefficient, since they can no accumulate sufficient quantities of energy so that a consumer can operate with the stored electrical energy over a long time. Also the existing electrical batteries have significant dimensions. It is believed that the existing electrical batteries can be further improved.

### SUMMARY OF THE INVENTION

Accordingly it is an object of the present invention to provide an electrical battery, which is more efficient than the existing batteries and has a small size.

In keeping with these objects and with others which will become apparent hereinafter, one feature of the present invention resides, briefly stated, in an electrical battery which has a housing, two electrodes chargeable with electrical charges of different signs in a polarizable medium provided between the electrodes, the polarizable medium being formed as an electrolyte which does not electrochemically interact with the electrodes but provides electrical charges which are attracted to electrical charges of the electrodes and vice versa so that the electrical charges accumulate near surfaces of the electrodes.

When the electrical battery is designed in accordance with the present invention, it accumulates a great quantity of electrical energy and has small dimensions.

In accordance with another feature of the present invention, two outer chambers are formed outside of the electrodes and filled with polarizable medium, and two further charging electrodes are provided, so that a charging device is formed in the electrical battery for charging the primary electrodes.

In accordance with a further feature of the present invention, the electrical battery is provided with a separate electrical energy transmitting device for transmitting from the battery an electrical energy which constitutes an insignificant fraction of the electrical energy stored in the battery. The transmitting device can include a dosing device and a converting device.

The dosing device of the energy transmitting device withdraws a relatively small quantity of electrical energy from the battery, while the converting device converts electrical parameters of the withdrawn energy into electrical parameters suitable for a consumer.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view one component of an electrical battery in accordance with the present invention with electrodes arranged in the housing;

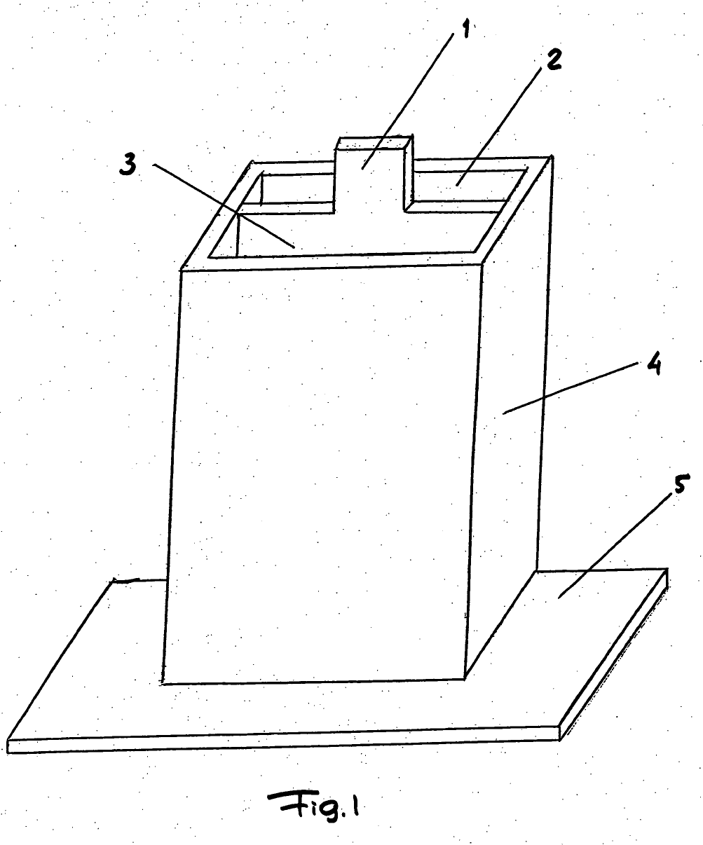

FIG. 2 is a view showing the electrical battery in accordance with the present invention, assembled of two components shown in FIG. 1;

FIG. 3 is a view showing a transverse cross-section of the electrical battery shown in FIG. 2;

FIG. 4 is a view showing a structure for transmitting energy from the battery to an energy transmitting device;

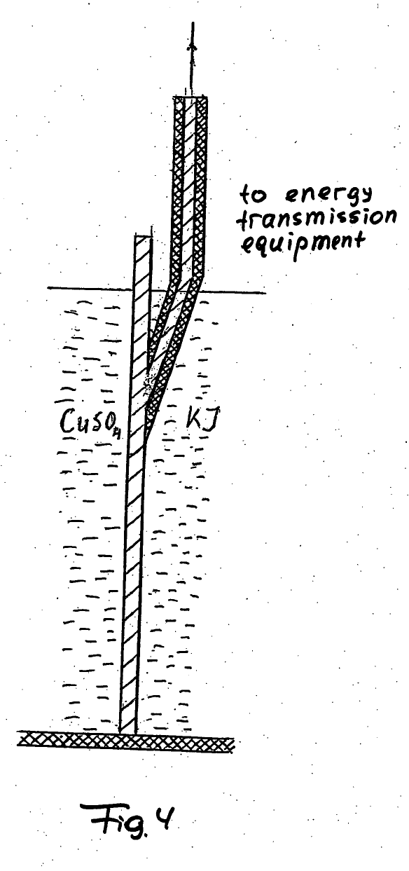

FIG. 5 is a view showing an additional electrode of the electrical battery shown in FIG. 2;

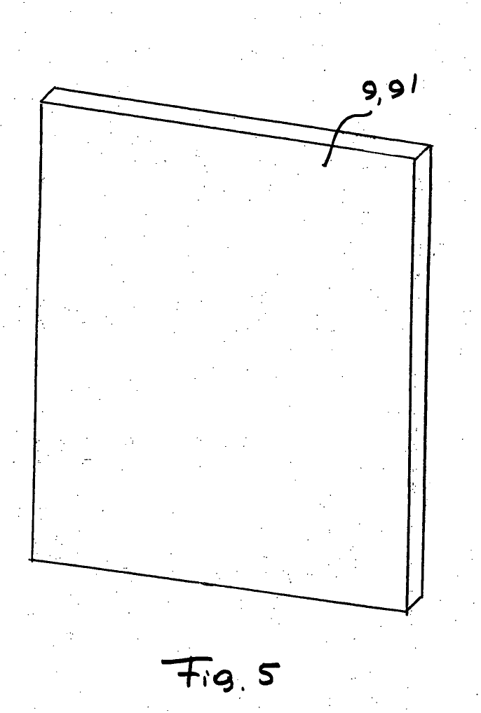

FIG. 6 is a view showing an electrode of the electrical battery shown in FIG. 2;

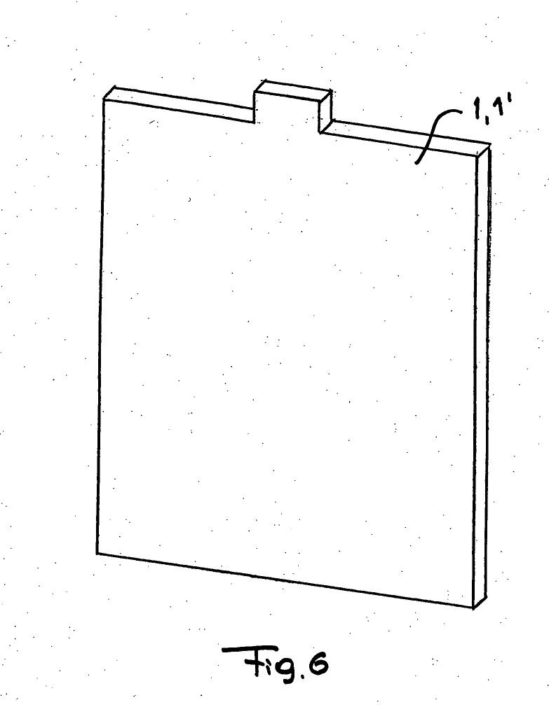

FIG. 7 is a view showing a separating element of the electrical battery shown in FIG. 2;

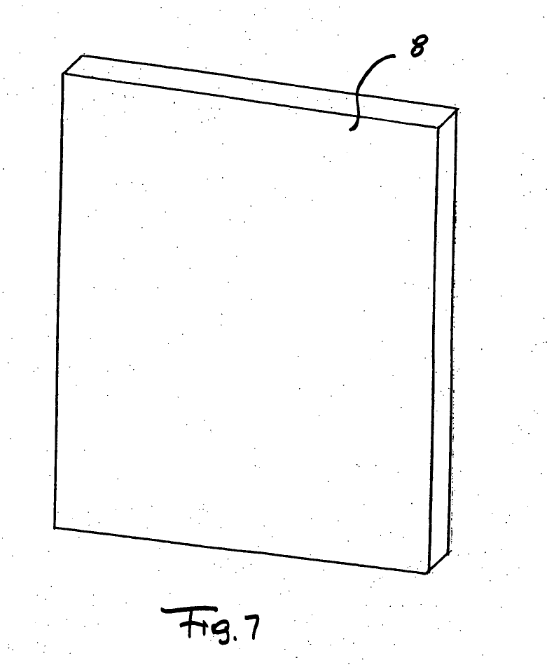

FIG. 8 is a view showing a cross-section of the battery which is charged by the charging device and transmits energy to the energy transmitting device; and

FIGS. 9a and 9b are views 10 is a view showing a cross-section of the energy transmitting device.

### DESCRIPTION OF THE PREFERRED EMBODIMENTS

An electrical battery in accordance with the present invention has a housing which can be composed of two housing parts 4 and 4′. Two electrodes 1 and 1′ are arranged inside the housing and form an inner chamber provided between the electrodes and composed of chambers 2 and 2′. Also two outer chambers 3 and 3′ are provided between the electrodes and the walls of the housing. Reference numerals 5 and 5′ identifies a support for the battery. All walls of the housing and the support are composed of a dielectric material. The walls and the support are hermetically connected with one another.

A separating element is provided between the chambers 2 and 2′. It can be formed as a partition between the housing parts 4 and 4′ and composed of a material with high resistance to electrical breakthrough, for example as a plate of a molten quartz, a container-filled with a NaCl, etc. Also, one of the walls or both walls of the housing parts, which face towards one another, can be formed as such separating element.

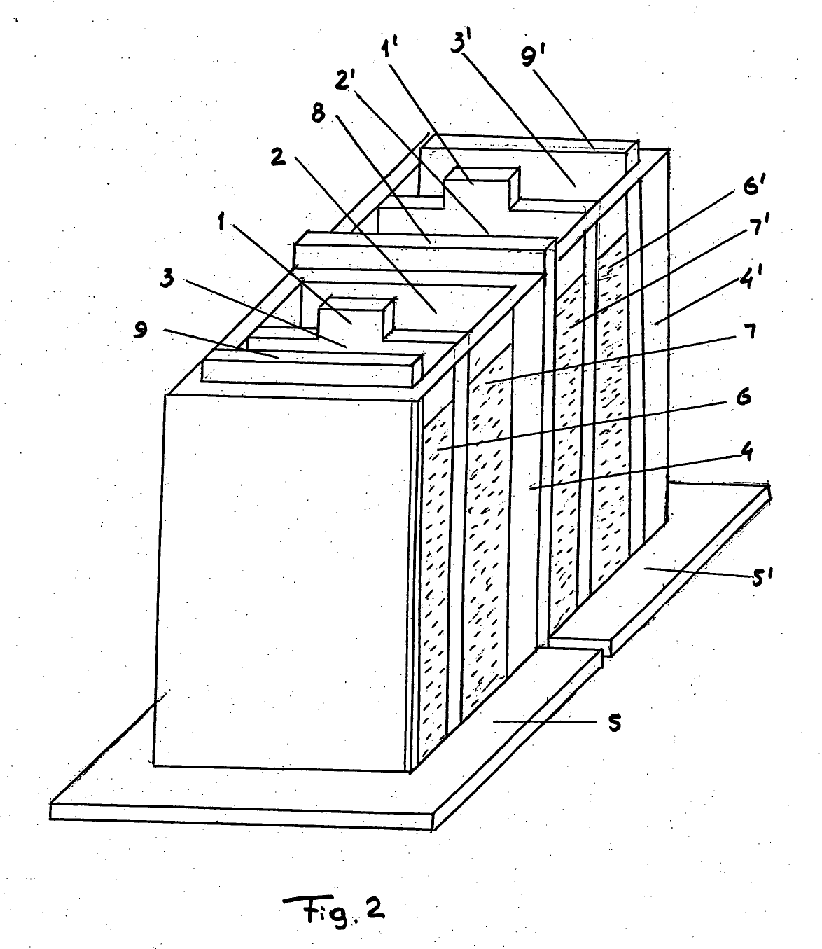

As can be seen from FIG. 2, the inner chamber of the battery composed of the chambers 2 and 2′ which serves for accumulation of electrical energy is filled with a polarized electrolyte 7, 7′. The polarized electrolyte 7, 7′ is selected so that it does not electrochemically interact with the electrodes 1 and 1′, but provides electrical charges which are attracted to electrical charges of the electrodes, and vice versa. For example, in the chambers 2, 2′ saturated solution of KJ or saturated solution of NaCl can be used, while the electrodes 1 and 1′ can be composed in this case of copper. The saturated solution of KJ provides a concentration of positive ions K⁺ and correspondingly negative ions J⁻N=5.2××10²¹ ion/cm³. The saturated solution of NaCl provides concentration of positive ions Na⁺ and correspondingly negative ions Cl⁻N=4×10²¹ ion/cm³.

Advantageous properties of KJ in the electrolyte where there are negative ions J⁻ and positive ions K⁺ are exhibited in that the negative ions J⁻ are formed after atoms of J obtain one electron and electronic shell of ions J⁻ became as in inert gas Xe with the structure (2818188) in layers of electrons. Correspondingly positive ions K⁺ are formed after atoms of K lost one electron, and electronic shell of ions K⁺ become as inert gas Ar (288) in the layers of electrons. It is known that inert gasses do not interact with other elements, including copper electrodes.

The concentrated solution of NaCl in electrolyte has the same properties. It has negative ions Cl⁻ and positive Na⁺, wherein negative ions Cl⁻ are formed after atoms of Cl obtain one electron and electronic shell of ion Cl⁻ become as in inert gas Ar with the structure (288) in the layers of electrons, while correspondingly positive ions Na⁺ are formed after atoms Na lost one electron and electronic shell of ions Na⁺ become as inert gas Ne (28). Therefore, the electrolyte based on Cl⁻ and Na⁺ do not interact with copper electrodes, similarly to the inert gas.

The walls of the copper electrodes 1 and 1′ facing the polarized electrolyte 7, 7′ are covered by a protective layer, such as for example a layer of Ni, which additionally prevents interaction of the electrodes with the polarized electrolyte.

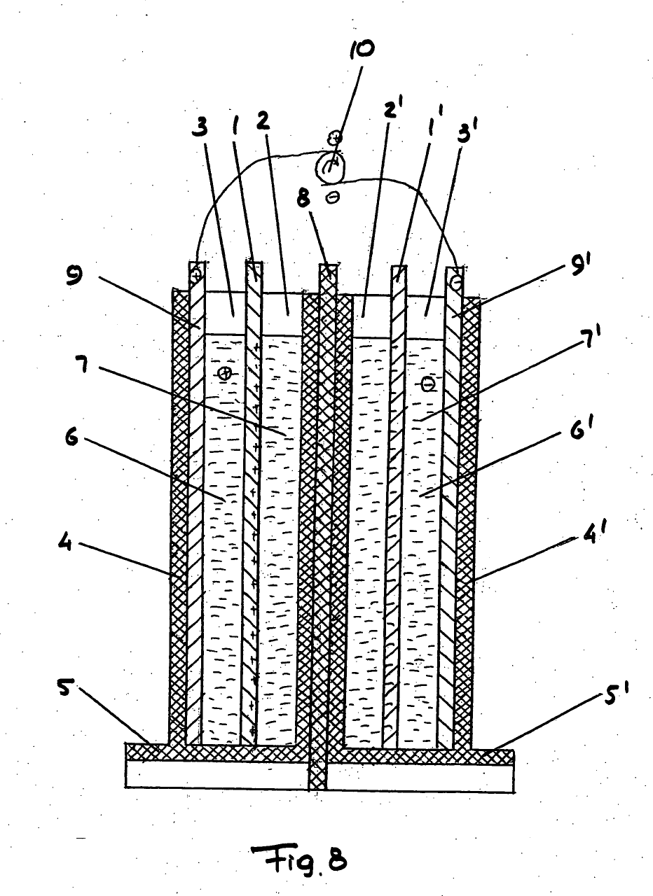

Since both the positive ions K⁺ or Na⁺ as well as negative ions of J⁻ and Cl⁻ are movable in the electrical field to the copper electrodes 1 and 1′, the negative ions move toward the positive copper electrode and with their charges completely block the electrical field near the surface of the positive copper electrode 1, while positive ions move toward the negative copper electrode and with their charges completely block the electrical field near the surface of the negative copper electrode 1′, so as to provide a great electrical capacity of the battery. In this way the action of the polarized electrolyte 7, 7′ accommodated between the copper electrodes 1 and 1′ is exhibited, as shown in FIG. 8.

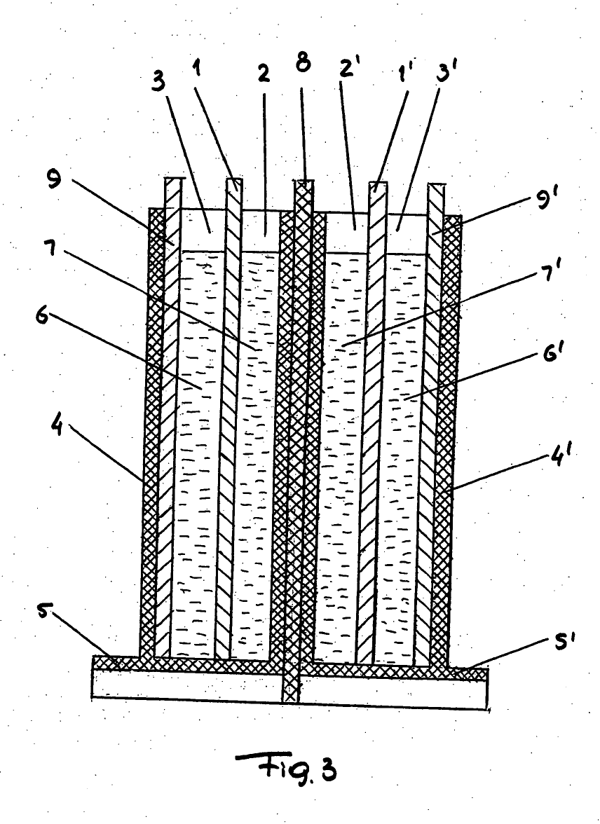

Before the battery is charged, the potentials of the copper electrode 1 and the copper electrode 1′ are equal to zero. Therefore, as a result of this, before charging of the battery the electrolyte 7, 7′ in the chambers 2, 2′ is homogenous. A capacitor formed by two copper electrodes 1 and 1′ in FIG. 8 is preliminarily charged to a desired voltage, for example V=220-1000 volt. Therefore the copper electrode 1 has a potential with + sign, while the copper electrode 1′ has a potential with − sign. With such preliminary charging the opposite charges located on the opposite copper electrodes 1 and 1′ in FIG. 3, as a result of mutual attraction, are accumulated near the surfaces of the copper electrodes 1 and 1′ which face one another, or in other words toward the electrolyte 7, 7′. The opposite surface of the copper electrode 1 facing an electrolyte 6, and an opposite surface of the copper electrode 1′ facing an electrolyte 6′ in FIG. 3 remain neutral. There are no charges on these opposite surfaces in accordance with law of physics.

In accordance with electrochemical laws, the positively charged surface of the copper electrode 1 located in the chamber 2 and facing toward the electrolyte 7 attracts negative ions for example of J⁻ from the electrolyte 7 to the charged surface of the copper electrode and repels from the charged surface the positive ions K⁺. Correspondingly, the negatively charged surface of the copper electrode 1′ in the electrolyte 7′ attracts from the electrolyte 7′ positive ions K+ to the charged surface of the copper electrolyte 1′ and repels negative ions J⁻. Therefore, during a simultaneous action of the copper electrode 1 and the copper electrode 1′ a polarization of the electrolyte 7, 7′ takes place. The negative ions j⁻ block the electrical field near the surface of the positive electrode 1, while the positive ions K⁺ block electrical field near the surface of the negative electrode 1′ in FIG. 3.

As a result, the polarized electrolyte acts similarly to a polarized dielectric, when the negative charge at one side of the polarized dielectric is concentrated near the surface of the positive copper electrode, and correspondingly when the positive charge at the opposite side of the polarized dielectric near the surface of the negative copper electrode blocks the electrical field near the negative copper electrodes.

The polarization of the electrolyte is realized as a result of a free moveability of both positive and negative charges in an electric field. The greater magnitude of electrical field, the stronger mutual shift of the charges in the polarized electrolyte, the stronger the efficiency of the dialectrical permeability of the electrolyte exhibits itself.

After a preliminarily charging the opposite wall of the copper electrode 1 facing the electrolyte 6 does not have charges and therefore it is neutral and has a potential equal 0, since during the preliminary charging on the copper electrode 1 because of the mutual attraction with charges of the opposite side of the copper electrode 1′ they are on the front surface of the copper electrode 1. Correspondingly, the opposite surface of the copper electrode 1′ facing the electrolyte 6′ does not have charges and therefore it is neutral and has a potential equal 0, since during the preliminary charging on the copper electrode 1′ because of the mutual attraction with the charges of the opposite sign on the copper electrode 1 they are on the front surface of the copper electrode 1′.

After the preliminary charging, in order to subsequently accumulate a great quantity of electrical energy, the chamber 3 is filled with the electrolyte 6 and the chamber 3′ is filled with electrolyte 6′, which are both composed of a saturated solution, for example of CuSO₄ which is used for charging the battery to a high voltage. As shown in FIG. 3, for charging an additional electrode 9 is located in the chamber 3 and an additional electrode 9′ is located in the chamber 3′. The electrodes can be composed of copper. The copper electrode 9 has a good contact with the electrolyte 6, while the copper electrode 9′ has a good contact with the electrolyte 6′. A charging device 10 shown in FIG. 8 applies a small potential difference for example V=220-1000 volt between the electrodes 9 and 9′, so that the electrode 9 has a plus potential and the electrolyte 6 in the chamber 3 also has a plus potential, while the electrode 9′ in the chamber 3′ has a minus potential and the electrolyte 6′ in the chamber 3′ also has a minus potential. Therefore, in the chambers 3 and 3′ the electrodes 9 and 9′ and correspondingly electrolytes has opposite sign potentials.

When the charging device 10 shown in FIG. 8 applies to the electrode 9 located in the electrolyte 6 a plus potential, then as a result of a good contact of the electrode 9 with the electrolyte 6 on the one hand and a high permeability of the saturated aqueous solution of CuSO₄ of the electrolyte 6 at the other side, the electrolyte 6 obtains a positive potential. The opposite neutral surface of the electrode 1 which has a zero potential, has a negative potential difference relative to the positively charged electrolyte 6 with a high concentration of ions. Therefore the positive ions Cu⁺⁺ are attracted to a large front surface of the copper electrode 1 with a zero potential, and great current is supplied for charging of the battery. Positive ions Cu⁺⁺ which reach the surface of the copper electrode 1 from the side of the electrolyte 6, are neutralized as a result of the electrochemical reaction and take electrons from the copper electrode 1, so as to charge it through the neutral surface facing the electrolyte 6 positively while neutral atoms of Cu are deposited on the surface of the copper electrode 1. A mass of the copper electrode 1 increases.

An insufficient quantity of negative electrons leads to immediate redistribution of electrons in metal. Absent electrons inside the metal are replenished very fast and easy from the side of the charged surface of the copper electrode 1, since on the charged surface of the copper electrode positive charges are attracted, while negative charges are correspondingly repelled by action from the side of the opposite negative electrode 1′. Electrons which left from the side of the charged surface of the copper electrode 1 increase therefore a positive charge on this surface and correspondingly a positive potential of the copper electrode 1 increases. As a result of this redistribution of the charges inside the metal copper electrode 1, the electrostatic field disappears and becomes equal to zero. Correspondingly, there are no electrical fields as a result of law of continuity also on the surface of the copper electrode 1 facing the electrolyte 6. The potential of this surface becomes equal to zero and is ready to receive continuously a high current of positive ions Cu⁺⁺. This side of the copper electrode 1 remains neutral, while on the surface of the copper electrode 1 facing the polarized electrolyte 7 a positive charge increases as a result of mutual attraction of the charges with opposite sign from the side of the surface of the copper electrode 1′ facing the surface of the copper electrode 1, and they are fixed here as a result of a mutual attraction.

Great density of charges in the electrolyte 6 provides high current flowing from the electrolyte 6 to the neutral surface of the copper electrode 1, which provides a fast charging of the battery, and at the same time a great surface of contact of the copper electrode 1 with the electrolyte 6 makes possible the operation with a low voltage charging.

At the same time, in the chamber 3 with the copper electrode 1 a negative ions SO⁻₄ move from the electrolyte 6 to the copper electrode 9 which has a plus potential and reach its surface. As a result of the electrochemical reaction the negative ions SO⁻₄ are neutralized and give their electrons to the copper electrode 9. SO₄ with two open links is connected with the copper electrode 9 so as to form a chemical composition CuSO₄, which immediately is dissolved and returned into the aqueous solution of CuSO₄— electrolyte 6, where molecules of CuSO₄ dissociate and form negative ion SO⁻₄ and a new positive ion Cu++, so that as a result of the dissolution of the copper electrode 9, negative ions SO⁻₄ is returned into the electrolyte, while because of the new positive ion Cu⁺⁺ in the electrolyte 6 that positive ion Cu⁺⁺ is compensated which left the electrolyte 6 for charging the positive copper electrode 1.

As a result of the electrochemical reaction on the electrode 9 the concentration is maintained and neutrality of the electrolyte 6 is maintained, while only the mass of copper of the copper electrode 9 changes. In particular, it mass reduces, while in the positive copper electrode 1 its mass increases. This has to be taken into consideration during selection of mass of the copper electrodes. The mass of the copper electrode 9 is selected with a surplus.

Correspondingly, when from the charging device 10 in FIG. 8 negative potential is applied to the electrode 9′ in the electrolyte 6′ as a result of good contact of the copper electrode 9′ with the electrolyte 6′ at the one side and high permeability of the electrolyte 6′ at the other side, the electrolyte 6′ obtains a negative potential. The opposite side of the copper electrode 1′ which has a zero potential has a positive potential difference relative to the negatively charged electrolyte 6′ with a high concentration of charges. Therefore the negative ions SO⁻₄ are attracted from the electrolyte 6′ to the surface of the copper electrode 1′ facing the electrolyte and great current is supplied for charging of the battery.

Negative ions SO⁻₄ reach the surface of the copper electrode 1′ from the side of the electrolyte 6′ and neutralize as a result of an electrochemical reaction so as to give its electrons, so that their electrons are given to copper electrode 1′ to charge, through a neutral surface facing the electrolyte 6′, the copper electrode 1′ correspondingly negatively. In the copper electrode 1′ additional negative charges-electrons are repelled from one another since they have same charges, which leads to an immediate redistribution of the electrons in the metal. Additional electrons inside the metal pass easy and fast onto the charged surface of the copper electrode 1′, since on the charged surface of the copper electrode 1′ negative charges-electrons are attracted from the side of the positively charged copper electrode 1. Electrons which reached the charged surface of the copper electrode 1′ increase the negative charge on this surface and correspondingly negative potential of the surface increases. As a result the difference of potentials of the battery is increased.

As a result of the redistribution of the charges inside the copper electrode 1′, the electrostatic field disappears and becomes equal zero inside the metal of the electrode. Correspondingly, there are no electrostatic fields because of law of continuity also on the surface facing the electrolyte 6′ of the electrode 1′. Potential of the surface remains equal zero. This surface of the copper electrode 1′ remains neutral, while on the surface of the copper electrode 1′ facing the polarized electrolyte 7′, the negative charge increases as a result of mutual attraction of the opposite sign charges from the side of the surface of the copper electrode 1 facing the surface of the copper electrode 1′ and they are fixed on this surface by this attraction.

In turn, SO₄ formed as a result of the electrochemical reaction on the opposite side of the copper electrode 1′ with two open bonds is connected on the opposite side with the copper electrode 1′ so as to form a chemical composition CuSO₄, which immediately is dissolved and returned into the aqueous solution of CuSO₄-electrolyte 6′, where a molecule CuSO₄ dissociates and forms a negative ion SO⁻₄ and a new positive ion Cu++, so that as a result of dissolution of the copper electrode 1′, negative ion SO⁻₄ and new positive ion Cu⁺⁺ are returned into the electrolyte 6′, which goes to the copper electrode 9′, gives this electrode a positive charge, and in form of neutral atoms of copper Cu is deposited on its surface. Mass of the copper electrode 9′ increases, while mass of copper electrode 1′ reduces. As a result of the electrochemical reaction on the opposite side of the copper electrode 1′ and on the electrode 9′ concentration and neutrality of the electrolyte 6′ is maintained, while only mass of copper of the copper electrode 1′ and the copper electrode 9′ changes.

The mass of copper electrodes 1′ reduces and the mass of the copper electrode 9′ increases. This is taken into consideration during selection of masses of electrodes. The mass of the electrode 1′ is taken with a surplus.

As a result, first of all the neutrality of both electrolyte 6 and electrolyte 6′ is maintained, and secondly the concentration of the electrolyte 6 and 6′ is maintained. Therefore, during charging of the battery it is possible to take a very small quantity both of the electrolyte 6 and the electrolyte 6′ and correspondingly the transverse sizes of the battery can be small, so that the total dimension of the battery is very small.

During charging of the battery to a high voltage, strong electrical fields on the outer surface of the electrode 1 and the electrode 1′ facing the polarized electrolyte 7, 7′ in FIG. 3 are blocked immediately near the surface of the copper electrode by the ions of the polarized electrolyte 7, 7′. The greater the voltage of the electrical field, the stronger the polarization of the electrolyte 7, 7′ directly near the surface of the copper electrode 1 and the copper electrode 1′, while the electrical field inside the electrolyte 7, 7′ is practically absent or negligibly small as a result of high dielectric permeability of the polarized electrolyte. The small value of voltage of the electrical field inside the electrolyte 7, 7′ and in particular the element 8 guarantee that there will be no breakthrough between the electrode 1 and the electrode 1′.

An important feature of the process of charging of the battery in the present invention is that the battery can be charged to a voltage which is very high, by means of the charging device with a low voltage, through the electrolyte 6 and the electrolyte 6′ in FIG. 3 and therefore it is not necessary to provide a separate charging device.

A huge capacity of the battery (C=10² farad) with voltage V=5×10⁵ volt on the terminals of the battery makes possible to provide a quantity of electrical energy in the battery W=1, 25×10¹³ J. With a power of electric motor W=300 Hp it is possible to drive an electric vehicle over the distance L=8×10⁵ miles without recharging of the battery. The battery operates with voltage V=3×10⁶, volt and with its area S=0.6 m² energy of the battery is W=3×10¹⁵ J. A tank with the power of an electric motor W=2×10⁴ kW will cover the distance L=400,000 miles without recharging.

As mentioned above, in the battery the plate of molten quartz SiO₂ can be used which has a limit to a breakthrough voltage 6.5×10¹¹ volt/M, or similar electrical breakthrough resisting element. With the thickness of the layer of the molten quartz SiO₂ 60 μm, it is possible to provide entry from the charged batteries with voltage V=3×10⁶ volt with 13 times surplus of resistance to breakthrough.

During the final process of charging, the electrolyte 6 from the chamber 3 and correspondingly the electrolyte 6′ from the chamber 3′ are removed, so that in the battery the whole accumulated energy is located on the outer surfaces of the copper electrodes 1 and 1′ facing the polarized electrolyte 7, 7′. The electrolyte 6 and 6′ are used only as a source of ions for charging of the battery. The battery is closed afterwards and is ready for final use by discharge to a consumer.

The discharge of the electrical battery for use of its electrical energy is described herein below. The discharge of the battery is performed so as to take a small quantity of electrical energy, (while actually it is a significant quantity), which is necessary for operation of an electric motor in a rational mode. In other words, because of the high voltage V=3×10⁵ volt on the terminals of the battery, during taking the energy for operation of the electric motor with the power W=2×10⁵ watt (272 Hp) low currents l=667 mAmp take place, while with the voltage V=3×10⁶ on the terminals of the battery during taking of the same power W=2×10⁵ watt for operation of the electric motor (272 Hp) even lower currents take place 1=67 mAmp. Low currents of discharge and high capacity of the battery allow to reduce a power necessary for operation of the electric motor during very long time without recharging of the battery. It is necessary that the consumer of the electrical energy-electrical motor also operate in a rational mode. For this purpose on the terminals of the electric motor it is necessary to have a smaller voltage, and in order to keep the taken power it is necessary to have high currents. This leads to simplification of the construction of the electric motor and creation of favorable conditions for its operation.

It is necessary that from a huge capacity of the electrical energy in the battery W=5×10¹² J, only a small quantity of energy is taken, which is necessary for operation of the electric motor, or in other words W=200 kW (272 Hp). If necessary, it is of course possible to take W=300 kW, W=500 kW, or in other words as necessary, and therefore to completely exclude with such high voltage on the terminals of the battery a discharge of the whole accumulated energy from the battery. On the terminals of the electric motor, the supplied lowered voltage must be stable during the whole time of operation of the electric motor. This guarantees a constant value of the current and stable operation of the electric motor.

This mode of operation is performed with the use of the energy transmitting device in accordance with the present invention.

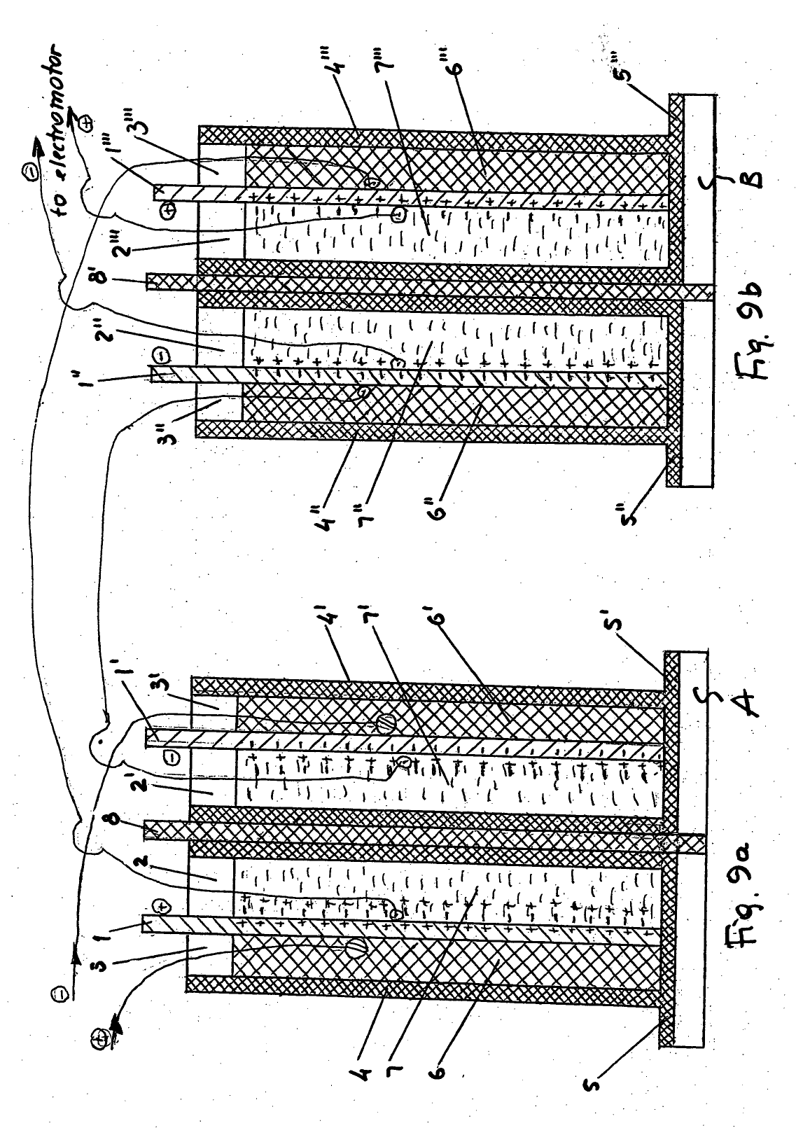

The energy transmitting device from the battery to the electric motor includes two blocks A and B shown in FIGS. 9a, 9b, 10. The block A contains a dosing device, or in other words a device which takes from the battery with a huge capacity of the electrical energy only a small quantity of energy which is necessary for a stationary operation of the electric motor. This limited quantity of energy from the block A at a high voltage is transmitted to the block B in which a coordinating or converting device is located for taking the limited quantity of energy from the block A with a high voltage and a low current, lowering the high voltage to a lower voltage necessary for operation of the electric motor, and simultaneously increasing electric current so that energy supplied to the terminals of the electric motor is for example W=200 kWatt with voltage V=10³ volt and current l=2×10² Amp. With corresponding parameters of the block B, the terminals of the electric motor can be provided also with other values of the voltage and current for a rational operation of the electric motor with a simple and reliable construction.

The block A or the dosing device has a housing composed of a dielectric material with two additional partitions providing three hermetically insulated sections. Two plates for example of copper are located in each section and form capacitors. The capacitors in each section are connected in series with one another. Each section is filled with electrolyte which is a diluted solution of KJ, or in other words having a very low concentration. The casing of the block A shown in FIG. 10a with two partitions 12 and 13 provides three hermetically insulated sections 14, 15, and 16. Two for example copper plates 1″ and 2″ are located in the section 14, two for example copper plates 3″ and 4″ are located in the section 15, and two covered plates 5″ and 6″ are located in the section 16. The thusly formed capacitors are connected in series by contacts 10 and 11. Each section is filled with an electrolyte which is a diluted solution of KJ with a low concentration, as identified with 7″. It is therefore possible to form a capacitor with a low capacity. The electrode 1″ is connected to the terminal of the battery with high voltage with sign plus, and the electrode 6″ is connected with the terminal of the battery with high voltage with minus sign as shown in FIG. 10a.

The copper electrode 1″ has a high potential with plus sign, while the copper electrode 6″ has a high potential with minus sign. The copper electrode 2″ in the vessel 14 and the copper electrode 3″ in the vessel 15 are connected by a conductor 10 and form a single conductor, and correspondingly the electrode 4″ in the vessel 15 is connected by a conductor 11 with the copper electrode 5″ in the vessel 16 to form a single conductor. During supply of voltage to the electrode 1″ with plus potential and to the electrode 6″ with minus potential on the electrodes 2″ and 3″ and correspondingly of the electrodes 4″ and 5″ induced charges are generated of the same value, but with opposite signs, when compared with the three capacitors connected in series with the electrodes 1″ and 2″ in the vessel 14 and electrodes 3″ and 4″ in the vessel 15 and the electrodes 5″ and 6″ in the vessel 16.

The electrolyte in the vessel 14 is located between the charged surfaces of the electrode 1″ with plus sign and the electrode 2″ with minus sign, the electrolyte in the vessel 15 and is located between charged surfaces of the copper electrode 3″ with plus sign and copper electrode 4″ with minus sign, and the electrolyte in the vessel 16 is located between charged surfaces of the copper electrode 5″ with plus sign and the copper electrode 6″ with minus sign. In other words, each electrolyte is located between the plates of a charged capacitor. In each electrolyte shown in FIG. 10a negative ions J⁻ move toward the surface of the positively charged surface of the copper electrode, while positive ions K⁺ move toward the negative surface of copper electrode. Polarization of the electrolyte in each section is thereby performed.

The parameters of the thusly formed capacitors are selected so that the capacity of each capacitor is very small and equals C=4×10⁻⁶_{farad} with voltage in the terminals of the battery V=3×10⁵ volt and C=4×10⁻⁸_{farad} with the voltage on the terminals of the battery V=3×10⁶ volt. Such a capacitor for each case has the energy W=CV²/2=2×10⁵ J. This makes possible from the huge quantity of energy in the battery W=5×10¹² J to take only small quantity of energy W=2×10⁵ J which is necessary for operation of the electric motor. The thusly formed capacitor with the selected parameters can not take more energy, since the parameters are selected correspondingly. This additionally guaranteed by the used electrolyte KJ, with a very low concentration, since here there is a significantly diluted electrolyte. An energy taken from the block A in FIG. 10 is taken from the electrode 2″ with plus potential which is the sign of the potential of the charged surface of the electrode 2, and from the electrode 5 with minus potential which is the sign of the potential of the charged surface of the electrode 5″. These two electrodes with opposite potential signs do not have a contact with one another. Therefore the potential with minus sign from the surface of the electrode 2″ is supplied through the contact 17 with high voltage to the copper electrode 6″ of the block B, and potential with plus sign from the surface of the electrode 5″ is supplied through the contact 18 with high voltage to the copper electrode 1′ of the block B.

All electrodes with high potential V=3×10⁵ volt or V=3×10⁶ are insulated by a coating of molten quartz SiO₂ which has a resistance to breakthrough 6.5×10¹¹ volt/m. Therefore with the voltage vehicle 3×10⁶ volt with 13-time resistance surplus, the thickness of the coating 60 μm, and with the voltage V=3×10⁵ volt with 13-time resistance surplus for breakthrough, the thickness of the insulating layer of molten quartz is 6 μm. These layers are not shown in the drawings because they are thin.

The coordinating or converting device or block B is shown in FIG. 10b. The positive copper electrode 5″ of the block A is connected by a conductor 18 with the copper electrode 1′″ of the block B, while the negative copper electrode 2″ of the block A is connected by a conductor 17 with the copper electrode 6′″ of the block B. Therefore, the limited quantity of energy obtained from the battery at a high voltage by the block A is transmitted to the block B or the converting device, which receives the limited quantity of energy from the block A with high voltage and reduces this high voltage to a lower voltage, and simultaneously increases electrical current, so as to create conditions for rational operation of the electric motor.

The block B has a housing with additional partitions forming three hermetically insulated sections. Each section accommodates cooperates plates which form a capacitor. Capacitors of the sections are connected in series with each other, so as to form a system of three capacitors. Each section is filled with electrolyte which is a saturated solution of KJ.

The partitions 12′ and 13′ form three sections 14′, 15′ and 16′ which are hermetically insulated from one another. The section 14′ has two copper plates 1′″ and 2′″, the section 15′ has two copper plates 3′″ and 4′″, and the section 16′ has two copper plates 5′″ and 6′″. The thusly formed capacitors are connected in series with one another by conductors 10′ and 11′. Each section is filled with electrolyte-saturated solution of KJ with high concentration-7′″. This makes possible to provide a capacitor with a high capacity.

The copper electrode 1′″ is connected by a conductor 18′ with copper electrode 5″ of the block A with plus sign, while the copper electrode 6′″ is connected through a conductor 17 with negative copper electrode 2″ with minus sign of the block 8. Therefore, the copper electrode 1′″ has a plus potential, while the copper electrode 6′″ has a minus potential. The electrode 2′″ in the section 14′ and the electrode 3′″ in the section 15″ are connected by the conductor 10′ to form a single conductor. The copper electrode 4′″ in the section 16′ is connected by the conductor 11′ with the electrode 5′″ and form a single conductor. On the copper electrodes 2′″ and 3′″ a correspondingly on the electrodes 4′″ and 5′″, when the voltage is supplied to the copper electrode 1′″ with plus potential and to the electrode 6′″ with minus potential, induced charges are generated with the same value but opposite signs as in three connected in series capacitors with electrodes 1″ and 2′″ in the vessel 14′, electrodes 3′″ and 4′″ in the vessel 15′, and electrodes 5′″ and 6′″ in the vessel 16′″. Therefore the electrolyte 7′″ in the vessel 14′ is located between two charged electrodes 1′″ with plus sign and electrode 2′″ with minus sign. The electrolyte in the vessel 15′ is located between the charged surfaces of the copper electrodes 3′″ with plus sign and the copper electrode 4′″ with minus sign. The electrolyte in the section 16′ is located between the charged surfaces of the copper electrode 5′″ with plus sign and the copper electrode 6′″ with minus sign. In other words every electrolyte of the block in B tis located between two plates of the charged capacitor. In each electrolyte negative ions J⁻ move toward the positively charged surface in the copper electrode, while the positive electrodes K⁺ move to the negative surface of the copper electrode. As a result polarization of the electrolyte 7′″ is performed. The capacity of the thusly formed capacitor is very high.

The energy is taken from the block B for supply to the terminals of the electric motor from the electrode 2′″ with minus potential which is a potential of the charged surface of the electrode 2′″, and from electrode 5′″ with plus potential which is a potential sign of the charged surface of the copper electrode 5″. These two electrodes with differential potential signs do not have a common contact there between. Therefore, the potential with minus sign from the surface of the copper electrode 2′″ is transmitted to one terminal of the electric motor, while the potential with the plus sign from the surface of the copper electrode 5′″ is transmitted to the other terminal of the electric motor.

The limited quantity of energy with high voltage and low current at the exit of the block A which has a low capacity C1 is supplied to the block B which has capacity C2, which is very high, as a result of the use of the polarized electrolyte of high concentration. This provides for a possibility to reduce the output voltage on the block B or in other words the terminals of the electric motor with the ratio C1/C2<<1. Since from the block A to the inlet electrodes 1′″ and 6′″ of the block B a high voltage is supplied, this makes possible to realize a high current at the output of the block B, or in other words on the terminals of the electric motor with the ratio C2/C1 >>1. Therefore in the dosing device A there is a very low capacity, a limited taking of energy from the battery, a high voltage and a low current at the output or in other words on the terminals of the block B, while in the coordinating or converting device B there is a very high capacity, a low voltage and a high current at the output or in other words on the terminals of the electric motor.

It will be understood that each of the elements described above, or two or more together, may also find a useful application in other types of constructions differing from the types described above.

While the invention has been illustrated and described as embodied in electrical battery, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. An electrical battery, comprising a housing; two electrodes chargeable with electrical charges of different signs in a polarizable medium provided between said electrodes, said polarizable medium being formed as an electrolyte which does not electrochemically interact with said electrodes but provides electrical charges which are attracted to electrical charges of said electrodes and vice versa.

2. An electrical battery as defined in claim 1, wherein said housing together with said electrodes form an inner chamber between said electrodes in which said electrolyte is accommodated, said housing further forming two outer chambers located at two opposite sides of said electrodes; and further comprising two further charging electrodes located in said two outer chambers; and two further quantities of an electrolyte located in each of said outer chambers between a respective one of said charging electrodes and a respective one of said first mentioned electrodes, each of said charging electrodes and said first mentioned electrodes having facing surfaces composed of a same material, and each of said quantities of said additional electrolyte being composed of an electrolyte which produces ions of a same material as said facing surfaces.

3. An electrical battery as defined in claim 1, wherein said housing is composed of a dielectric material.

4. An electrical battery as defined in claim 1; and further comprising an electrical energy transmitting device for transmitting from the battery an electrical energy which constitutes an insignificant fraction of an electrical energy stored in the battery.

5. An electrical battery as defined in claim 6, wherein said electrical energy transmitting device includes a dosing device having a casing provided with at least two supplemental electrodes and a supplemental electrolyte accommodated therebetween and selected so that said supplemental electrolyte does not electrochemically interact with said supplemental electrodes but produces electrical charges which are attracted with electrical charges produced on surfaces of said supplemental electrodes facing toward one another.

8. An electrical battery as defined in claim 7, wherein said supplemental electrolyte in said dosing device has a concentration which is significantly smaller than a concentration of said electrolyte between said first mentioned electrodes, so that said dosing device takes a relatively small quantity of electrical energy.

9. An electrical battery as defined in claim 7, wherein said supplemental electrodes include three pairs of electrodes formed so that each of said pairs includes a positive and a negative supplemental electrode, and said supplemental electrolyte includes three quantities of electrolyte each accommodated between each of said pairs of said supplemental electrodes.

10. An electrical battery as defined in claim 5, wherein said transmitting device also includes a converting device connected with said dosing device for converting electrical parameters of the electrical energy received from said dosing device so as to obtain an electrical energy of a lower voltage and of a higher current, said converting device including a casing with an additional polarized electrolyte and at least two converting electrodes with one converting electrode connected with said supplemental electrodes of said dosing device.

11. An electrical battery as defined in claim 10, wherein said additional electrolyte in said converting device has a higher concentration than said electrolyte in said dosing device.

12. An electrical battery as defined in claim 1, wherein said converting device includes three pairs of converting electrodes each forming a capacitor and having an electrolyte therebetween, wherein one negative and one positive of said converting electrodes of said converting device being connected with one negative and one positive electrode of said dosing device, while another negative and one positive of said converting electrodes of said converting device is connected with one negative electrode and one positive electrode of said dosing device, while another negative and another positive electrode of said converting device are connectable to a consumer.

12. An electrical battery as defined in claim 1, wherein said electrodes have surfaces facing toward said electrolytes and covered by a material which reduces a tendency of said electrodes for electrochemical interaction with said electrolyte.

13. An electrical battery as defined in claim 12, wherein said electrodes are composed of copper and their surfaces facing toward one another are coated with nickel.

14. An electrical battery as defined in claim 1, wherein said electrolyte is composed of a vitriol of a material, from which said electrodes are composed.

15. An electrical battery as defined in claim 1, wherein said housing is composed of two housing parts each forming a part of an inner chamber between said electrodes and each accommodating a respective one of said electrodes; and further comprising an element separating said parts of said inner chamber from one another and composed of an electrical breakthrough resistant material.
